(19) United States
(12) Patent Application Publication
(10) Pub. No.: US 2026/0187557 A1
(43) Pub. Date: Jul. 2, 2026

(54) A NATURAL GAS CONSUMPTION PREDICTION AND ANALYSIS SYSTEM

(71) Applicant: BASARSOFT BILGI TEKNOLOJILERI ANONIM SIRKETI, Çankaya, Ankara (TR)

(72) Inventor: Ahmet DABANLI, Çankaya, Ankara (TR)

(21) Appl. No.: 19/126,146

(22) PCT Filed: May 21, 2024
(86) PCT No.: PCT/TR2024/050499

§ 371 Date: Apr. 30, 2025

(30) Foreign Application Priority Data
Jul. 5, 2023 (TR) 2023/007796

(51) Int. Cl. G06Q 10/0631; G01W 1/02; G06Q 50/06

(52) U.S. Cl. CPC G06Q 10/06315; G01W 1/02; G06Q 50/06

(57) ABSTRACT

Disclosed is a natural gas consumption prediction and analysis system for use in the energy sector. The system determines the necessary parameters and coefficients for predicting natural gas consumption using real-time natural gas consumption data, meteorological data, and client characteristics, and forms client clusters.

### TECHNICAL FIELD

The invention relates to a natural gas consumption prediction and analysis system that is used in the energy sector, which determines the necessary parameters and coefficients for predicting natural gas consumption using real-time natural gas consumption data, meteorological data, and client characteristics, and which forms client clusters.

The invention particularly aims to provide the necessary information for reducing natural gas consumption (reducing money outflow and greenhouse gas emissions). Natural gas consumption prediction is performed using real-time data reading modules and communication devices over diaphragm and digital meters. The prediction application uses meteorological data, data from meters, users' residential addresses and home characteristics, and geographic information system data to make consumption predictions.

### BACKGROUND ART

Natural gas, an important component of the world's energy needs, is a significant energy source for many countries. However, as natural gas consumption increases, greenhouse gas emissions also rise, and climate change problems increase. Therefore, measuring and converting natural gas consumption into meaningful data is vital for enhancing energy efficiency and reducing greenhouse gas emissions.

Natural gas consumption comes from various sources, including energy companies, industrial facilities, and households. However, effectively measuring and analyzing consumption is a fundamental step in forming sustainable energy policies. For this purpose, energy companies and governments must adopt advanced measurement and data collection systems to monitor and report natural gas consumption.

Merely collecting data on natural gas consumption is not enough; it is crucial to make this data meaningful and convert it into usable information. These analyses provide important insights for developing energy management strategies and achieving energy savings.

Moreover, integrating natural gas consumption data with other factors is also important. For example, variables such as air temperature, climate conditions, and building insulation can affect natural gas consumption. By considering these factors, more accurate predictions can be made, and energy efficiency can be improved.

Natural gas energy is a significant energy source used by many households and businesses. However, it is essential to make predictions based on accurate and real-time data regarding natural gas consumption. Such predictions provide great benefits in terms of energy management and resource planning. Current systems generally rely on limited data and can make errors in predictions. Therefore, there is a need for a new system and method that will improve real-time natural gas consumption prediction.

As a result of research conducted in the literature, a Chinese patent application with the reference “CN114997525,” titled “Natural gas consumption prediction method and device based on grey neural network, and medium,” was found. The abstract of this application states: “The invention discloses a natural gas consumption prediction method based on a grey neural network, a natural gas consumption prediction device, and a natural gas consumption prediction medium. The method includes the following steps: obtaining historical natural gas consumption data and performing principal component analysis on the historical natural gas consumption data to obtain principal component variables after dimensionality reduction; obtaining current natural gas consumption data of the region corresponding to the principal component variable; and inputting the region's current natural gas consumption into a natural gas consumption prediction model based on a grey neural network to obtain a regional natural gas consumption prediction result.” This invention improves the prediction result of natural gas consumption. However, the system described in the invention improves the prediction result without using meteorological data, users' residential addresses and home characteristics, or geographic information system data, and therefore, it cannot produce a real-time and accurate prediction result.

In another research in the literature, a Chinese patent application with the reference “CN115860795,” titled “Markov theory-based short-term total natural gas consumption prediction method and system,” was found. The abstract of this application states: “The invention discloses a short-term total natural gas consumption prediction method and system based on Markov theory. The method includes the steps of: taking the real value and the predicted value of daily short-term total natural gas consumption in a first time period before a date to be predicted as a first data set; performing parameter optimization in a support vector machine prediction model by an adaptive angle division-based multi-objective particle swarm optimization algorithm to obtain the first prediction result corresponding to the short-term total consumption and a total consumption prediction model using the first data set to predict the natural gas consumption of the date to be predicted; and correcting the first prediction result through a Markov model and the first data set to obtain a corresponding second prediction result. According to the method, the total short-term natural gas consumption of the date to be predicted is predicted in advance by combining past data of the total short-term natural gas consumption based on the support vector machine prediction model, and the preliminary prediction result is corrected by the Markov model to improve the prediction accuracy and prediction efficiency of the total short-term natural gas consumption.” This method can produce accurate results under certain conditions because it does not consider the additional parameters mentioned above.

In conclusion, due to the aforementioned shortcomings and the inadequacy of existing solutions regarding the subject matter, it is deemed necessary to make an improvement in the relevant technical field.

### Objective of the Invention

The primary objective of the invention is to provide a solution for determining the parameters necessary for predicting natural gas consumption using real-time natural gas consumption data, meteorological data, and client characteristics, and for forming client clusters. To achieve this, real-time natural gas consumption data is collected using diaphragm and digital meters and transmitted to the consumption prediction application via communication devices.

Another objective of the invention is to predict natural gas consumption based on a database that includes meteorological data, data from meters, users' residential addresses and home characteristics, and geographic information system data. These predictions are based on real-time data and utilize statistical analysis and data mining techniques to determine the necessary parameters. Predictions are calculated according to client clusters and are used to model the total natural gas consumption in the city.

Another objective of the invention is to provide the necessary information to reduce natural gas consumption. This can help reduce money outflow from the country and control greenhouse gas emissions. Moreover, accurate and real-time natural gas consumption predictions play a crucial role in energy management and resource planning.

To fulfill the above objectives, the invention is a natural gas consumption prediction and analysis system designed to be used in the energy sector, capable of working integratedly with diaphragm gas meters and digital gas meters, characterized by: at least one database that stores the foundational data for natural gas consumption predictions, including meteorological data, real-time data from diaphragm gas meters and digital gas meters, user information, and geographic information system data, a natural gas consumption and analysis application that uses meteorological data, real-time consumption data from diaphragm gas meters and digital gas meters, users' addresses and home characteristics, and geographic information system data to make consumption predictions; it determines the parameters for calculating natural gas consumption using statistical analysis and data mining techniques and performs predictions according to client clusters, at least one client server that stores data enabling the natural gas consumption and analysis application to make natural gas consumption predictions based on the characteristics of the clients, at least one meteorology server that stores data enabling the natural gas consumption and analysis application to make predictions based on meteorological data.

### BRIEF DESCRIPTION OF THE DRAWINGS

FIG. 1 is a representative view of the natural gas consumption prediction and analysis system that is the subject of the invention.

### DESCRIPTION OF REFERENCES TO PARTS

A. Natural Gas Consumption and Analysis System
   1. Natural Gas Consumption and Analysis Application
      1.1 Database
   2. Diaphragm Gas Meter
      2.1 Real-time Data Recording Device
      2.2 Diaphragm Gas Meter Communication Module
   3. Digital Gas Meter
      3.1 Real-time Data Reading Port
      3.2 Digital Gas Meter Communication Module
   4. Client Server
   5. Meteorology Server

### DETAILED DESCRIPTION OF THE INVENTION

This detailed description explains the preferred embodiments of the invention only to better understand the subject matter and without creating any limiting effect.

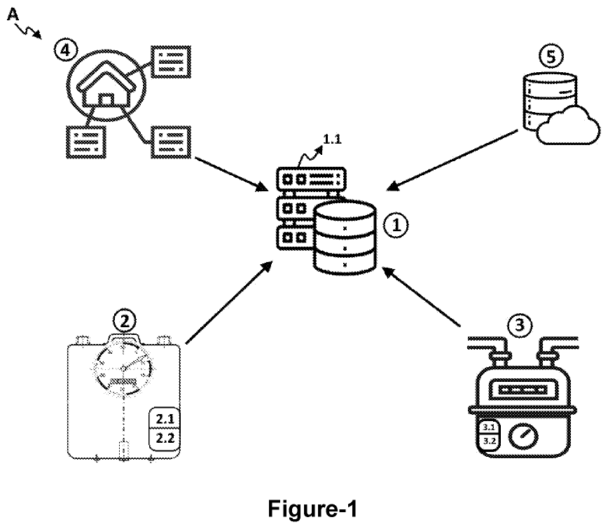

Referring to FIG. 1, the natural gas consumption and analysis system (A) subject to the invention consists of the following components:

Natural gas consumption and analysis application (1): This is the software application that performs natural gas consumption predictions. This application (1) makes consumption predictions using meteorological data from the database (1.1), real-time data from diaphragm gas meters (2) and digital gas meters (3), users' addresses and home characteristics, and geographic information system data. It uses statistical analysis and data mining techniques to determine the necessary parameters and makes predictions according to client clusters. Additionally, the natural gas consumption and analysis application (1) can make future consumption predictions based on user/usage clusters created through data mining and artificial intelligence algorithms.

Database (1.1): This is the database (1.1) where the foundational data for natural gas consumption predictions is stored (1.1). This database (1.1) includes various data sets such as meteorological data, real-time data from diaphragm gas meters (2) and digital gas meters (3), user information, and geographic information system data. These data are used for making natural gas consumption predictions.

Diaphragm Gas Meter (2): The diaphragm gas meter (2) is a device that collects natural gas consumption data. It consists of a real-time data recording device (2.1) and a diaphragm gas meter communication module (2.2). The real-time data recording device (2.1) measures and records natural gas consumption in real-time. The diaphragm gas meter communication module (2.2) transmits the collected data to the natural gas consumption prediction application (1).

Real-time Data Recording Device (2.1): This device (2.1), which is a part of the diaphragm gas meter (2), measures and records natural gas consumption in real-time. These data form the basis of natural gas consumption predictions.

Diaphragm Gas Meter Communication Module (2.2): This module (2.2) provides communication between the diaphragm gas meter (2) and the natural gas consumption prediction application (1). This module (2.2) ensures the use of up-to-date data by transmitting real-time data to the natural gas consumption prediction application (1). The presence of the diaphragm gas meter communication module (2.2) is not mandatory. In cases where this module is not present, real-time recorded information from diaphragm devices is manually or semi-manually recorded into the database.

Digital Gas Meter (3): This is another device that collects natural gas consumption data. It consists of a real-time data reading port (3.1) and a digital gas meter communication module (3.2). The real-time data reading port (3.1) reads natural gas consumption data and ensures its transmission through the digital gas meter communication module (3.2).

Real-time Data Reading Port (3.1): This port (3.1), which is part of the digital gas meter (3), reads natural gas consumption data. These data form the basis of natural gas consumption predictions.

Digital Gas Meter Communication Module (3.2): This module (3.2) provides communication between the digital gas meter (3) and the natural gas consumption prediction application (1). This module (3.2) ensures the use of up-to-date data by transmitting real-time data to the natural gas consumption prediction application (1). The presence of the digital gas meter communication module (3.2) is not mandatory, and digital meters without this module are read manually through the port and transferred to the database.

Client Server (4): This server (4) contains information related to clients, such as apartment area, orientation, floor, height, insulation, and geographic information system data, including address characteristics and address information. This server (4) ensures that natural gas consumption predictions are made according to the characteristics of the clients.

Meteorology Server (5): This server (5) stores meteorological data and is used in natural gas consumption predictions. This server (5) provides data related to weather conditions such as temperature, pressure, wind, and humidity and transmits these data to the natural gas consumption prediction application (1), which uses them as factors affecting natural gas consumption.

Using these part references, the invention ensures the collection, analysis, and conversion of necessary data for natural gas consumption predictions into usable information. The accuracy of natural gas consumption predictions and their basis on real-time data are crucial for developing energy management strategies, achieving energy savings, and reducing natural gas consumption.

The Geographic Information System (GIS) is a system where geographical data are stored and managed. This system contains location information of clients. GIS data ensure that geographical factors are considered in natural gas consumption predictions. For example, climate conditions and energy consumption habits can vary depending on the region.

Statistical analysis and data mining techniques are used to analyze the data that form the basis of the natural gas consumption prediction and analysis system. Statistical analysis methods identify trends, seasonal effects, and other relationships in historical consumption data. Data mining techniques are used to discover hidden relationships and patterns among the data.

Natural gas consumption predictions enable the forecasting of future consumption of users. These predictions consider factors such as seasonal effects, temperature, client characteristics, and other factors. Predictions are a crucial tool for energy companies' resource planning, energy demand management, and energy efficiency efforts.

Natural gas consumption predictions are made by grouping clients with similar characteristics. This makes predictions more accurate and reliable for clients with similar consumption habits. Client clusters are formed using information from the client server (4) and statistical analysis techniques.

The invention encompasses a system for collecting, analyzing, and making predictions of the necessary data for predicting and analyzing natural gas consumption. This enables the energy sector to improve efficiency, control natural gas consumption, and reduce environmental impacts.

The working principle of the invention consists of the following steps:
real-time natural gas consumption data are collected through diaphragm and digital gas meters (2,3). The diaphragm gas meter communication module (2.2) and the digital gas meter communication module (3.2) are used to transmit these data to the natural gas consumption and analysis application (1),
information related to clients is stored in the client server (4). This information includes the clients' residential addresses, home characteristics, and other client attributes. The data obtained from the client server (4) ensure that natural gas consumption predictions are made according to the clients' characteristics,
weather conditions, temperature, and other meteorological data stored in the meteorology server (5) are used as factors affecting natural gas consumption. These data are transmitted to the natural gas consumption and analysis application (1) to ensure more accurate and reliable predictions,
the database (1.1) that forms the basis of the natural gas consumption and analysis application (1) contains meteorological data, data from meters (2,3), client data, and geographic information system data. This database (1.1) provides access to the data used for making consumption predictions,
statistical analysis and data mining techniques are applied to the data in the database (1.1). These techniques identify trends in historical consumption data, analyze seasonal effects, and discover other relationships. This ensures more accurate and reliable consumption predictions,
the natural gas consumption prediction application (1) makes predictions using real-time natural gas consumption data, meteorological data, client data, and other factors. Predictions are made according to client clusters using parameters and coefficients determined through statistical analysis and data mining techniques.

The working principle of the invention involves the processes of data collection, data analysis, and prediction by the natural gas consumption prediction and analysis system (A). This system (A) provides an important tool for energy companies and governments to monitor natural gas consumption, improve energy efficiency, and optimize resource planning.

1. A natural gas consumption prediction and analysis system for use in the energy sector, capable of working integratedly with diaphragm gas meters and digital gas meters, the system comprising:
at least one database that stores foundational data for natural gas consumption predictions, including meteorological data, real-time data from diaphragm gas meters and digital gas meters, user information, and geographic information system data;
a natural gas consumption and analysis application that uses meteorological data, real-time consumption data from diaphragm gas meters and digital gas meters, users' addresses and home characteristics, and geographic information system data to make consumption predictions; it determines the parameters for calculating natural gas consumption using statistical analysis and data mining techniques and performs predictions according to client clusters;
at least one client server that stores data enabling the natural gas consumption and analysis application to make natural gas consumption predictions based on the characteristics of the clients; and;
at least one meteorology server that stores data enabling the natural gas consumption and analysis application to make predictions based on meteorological data.

2. The natural gas consumption prediction and analysis system according to claim 1, wherein the client server contains data related to the clients, including apartment area, orientation, floor, height, insulation, and address characteristics pertaining to the geographic information system.

3. The natural gas consumption prediction and analysis system according to claim 1, wherein the meteorology server-contains data related to climate conditions such as temperature, pressure, wind, and humidity.

4. The natural gas consumption prediction and analysis system according to claim 1, characterized in that it includes comprising at least one real-time data recording device-located in the diaphragm gas meter, which measures and records natural gas consumption in real-time, and a diaphragm gas meter communication module that facilitates communication between the diaphragm gas meter and the natural gas consumption prediction application by transmitting real-time data to the application.

5. The natural gas consumption prediction and analysis system according to claim 1, comprising at least one real-time data reading port that enables the digital gas meter to read natural gas consumption data, and a digital gas meter communication module that facilitates communication between the digital gas meter and the natural gas consumption prediction application by transmitting real-time data to the application.
